(19) United States
(12) Patent Application Publication
(10) Pub. No.: US 2024/0193434 A1
(43) Pub. Date: Jun. 13, 2024

(54) Federated Learning System and Federated Learning Method

(71) Applicant: Hitachi, Ltd., Tokyo (JP)

(72) Inventors: Yuichi KITAGAWA, Tokyo (JP); Masayuki TAKASE, Tokyo (JP); Takahito TANIMURA, Tokyo (JP)

(21) Appl. No.: 18/512,618

(22) Filed: Nov. 17, 2023

(30) Foreign Application Priority Data
Dec. 7, 2022 (JP) 2022-195982

(51) Int. Cl. G06N 3/098

(52) U.S. Cl. CPC G06N 3/098

(57) ABSTRACT

A federated learning system using a smart-contract-based blockchain technology is provided. The system includes: a first information processing apparatus including an initial federated learning model; and a second information processing apparatus that trains an initial federated learning model delivered from the first information processing apparatus. The first information processing apparatus includes an initial federated learning model sharing contract that is a smart contract used to share the initial federated learning model with the second information processing apparatus, the smart contract including reward information on a reward as a token that a user of the first information processing apparatus receives from a user of the second information processing apparatus for the sharing of the initial federated learning model.

### BACKGROUND OF THE INVENTION

### 1. Field of the Invention

The present invention relates to a federated learning system and a federated learning method.

### 2. Description of the Related Art

In machine learning, particularly in the case of a deep neural network or the like that learns a complex model, collecting a large amount of various learning data is important. Federated learning (FL) is an approach to allow a number of clients to share only the model while holding local data and to update weight parameters, etc. FL thus realizes large-scale learning while protecting privacy and reducing communication traffic.

FL with a conventional model updating server deployed as a centralized server poses a problem that designing incentives to FL participants is difficult. As a solution to the problem, A. R. Short, H. C. Leligou and E. Theocharis, “Execution of a Federated Learning process in a smart contract,” 2021 IEEE International Conference on Consumer Electronics (ICCE), 2021, pp. 1-4, doi: 10.1109/ICCE50685.2021.9427734 discusses a method of giving incentives to FL participants by a reward scheme using tokens based on a blockchain technology.

### SUMMARY OF THE INVENTION

An architecture is considered, in which a system that executes FL on a blockchain is built and FL progresses through smart contracts. A method has been proposed, according to which an FL model performance verification unit for evaluating an FL collaborator's degree of contribution is incorporated in a smart contract and a reward according to the FL collaborator's contribution to FL is given as an incentive to the FL collaborator. The above method gives the FL collaborator an incentive for aggressive participation in FL. The method, however, does not offer sufficiently effective incentive design for giving incentives to FL clients.

Conventionally, for example, an improvement in the performance of an AI model by FL is considered to be an incentive to the FL client. However, when the fact that use of the blockchain technology has increased incentives to FL participants is taken into consideration, it leads to a perspective that incentive design for giving a more proper incentive to the FL client is necessary.

A typical example of the present invention disclosed herein is as follows. A federated learning system is a system using a smart-contract-based blockchain technology. The system includes: a first information processing apparatus including an initial federated learning model; and a second information processing apparatus that trains an initial federated learning model delivered from the first information processor. The first information processing apparatus includes an initial federated learning model sharing contract that is a smart contract used to share the initial federated learning model with the second information processing apparatus, the smart contract including reward information on a reward as a token that a user of the first information processing apparatus receives from a user of the second information processing apparatus for the sharing of the initial federated learning model.

A typical example of the present invention disclosed herein is as follows. A federated learning system is a system using a smart-contract-based blockchain technology. The system includes an initial federated learning model sharing contract that is a smart contract used to cause a second information processing apparatus that trains a model to share an initial federated learning model included in a first information processing apparatus that requests federated learning, the smart contract including reward information on a reward as a token that a user of the first information processing apparatus receives from a user of the second information processing apparatus for the sharing of the initial federated learning model.

A typical example of the present invention disclosed herein is as follows. A federated learning method using a smart-contract-based blockchain technology includes the steps of: a first information processing apparatuses' causing a second information processing apparatus to share an initial federated learning model, using an initial federated learning model sharing contract that is a smart contract used to allow the first information processing apparatus to cause the second information processing apparatus that trains a model to share the initial federated learning model; and the first information processing apparatuses' acquiring a reward as a token when the second information processing apparatus shares the initial federated learning model.

According to the present disclosure described above, in execution of FL, the FL client can receive a reward as a token and therefore a proper incentive scheme for the FL client is established. Problems, configurations, and effects that are not described above will be made clear by the following description of preferred embodiments.

### BRIEF DESCRIPTION OF THE DRAWINGS

FIG. 1 depicts an example of an overall configuration of an FL system using a smart-contract-based blockchain;

FIG. 2 is a diagram for explaining details of a configuration example of the FL system using the smart-contract-based blockchain;

FIG. 3 depicts an example of a task explanatory note made open to the public;

FIG. 4 depicts an example of writing information to a shared storage and a distributed ledger at execution of an FL smart contract;

FIG. 5 depicts an example of a smart table;

FIG. 6 depicts a configuration example of the FL smart contract and of the distributed ledger;

FIG. 7 is a flowchart showing an example of a flow of use of the FL system using the smart-contract-based blockchain;

FIG. 8 depicts an example of a sequence to make task participation determination;

FIG. 9 depicts an example of a sequence to execute an FL start contract;

FIG. 10 depicts an example of a sequence to execute an initial FL model sharing contract;

FIG. 11 depicts an example of a sequence to execute an FL model weight sharing contract;

FIG. 12 depicts an example of a sequence to execute an FL model updating contract; and

FIG. 13 depicts an example of a hardware configuration of an information processing apparatus used in an embodiment.

### DESCRIPTION OF THE PREFERRED EMBODIMENTS

An embodiment of the present invention will hereinafter be described with reference to the drawings. The embodiment is exemplary one for explanation of the present invention, and description of the embodiment involves omission and simplification, when necessary, to make the description clear. The present invention may also be implemented in various forms other than the embodiments. Unless otherwise specified, each constituent element may take a single form and a plural form as well without being limited to one of them.

The positions, sizes, shapes, ranges, and the like of constituent elements shown in the drawings may not represent the actual positions, sizes, shapes, ranges, and the like of the same for the reason that they are shown to facilitate understanding of the invention. The present invention, therefore, is not necessarily limited by positions, sizes, shapes, ranges, and the like shown in the drawings.

Pieces of information are described, for example, as “table”, “list”, “queue”, etc., in some cases. These pieces of information, however, may be expressed as data structures different from “table”, “list”, “queue”, etc. For example, pieces of information like “XX table”, “XX list”, “XX queue”, etc., may be referred to as “XX information”. Description of identification information involves various expressions like “identification information”, “identifier”, “name”, “ID”, “number”, etc., and these terms are interchangeable.

When a plurality of constituent elements that are entirely identical or identical in function with each other are present, such constituent elements may be denoted by the same reference sign with different subscripts attached thereto for clear description. When distinguishing these constituent elements from each other is unnecessary, however, the constituent elements may be described with the subscripts omitted therefrom.

In the embodiments, a process executed by running a program may be described. In such a case, a computer runs a program by a processor (e.g., a CPU or GPU), and executes a process defined by the program, using a storage resource (e.g., a memory), an interface device (e.g., a communication port), and the like. A main component that executes the process by running the program, therefore, may be considered to be the processor. Similarly, the main constituent element responsible for executing the process by running the program may be considered to be a controller, a device, a system, a computer, or a node having the processor. The main constituent element responsible for executing the process by running the program is provided as an arithmetic processing unit, which may include a dedicated circuit that carries out a specific process. The dedicated circuit refers to, for example, a field-programmable gate array (FPGA), an application specific integrated circuit (ASIC), a complex programmable logic device (CPLD), or the like.

A program may be acquired from a program source and installed in the computer. The program source may be, for example, a program distribution server or a computer-readable recording medium. When the program source is a program distribution server, the program distribution server may include a processor and a storage resource that stores a program to be distributed, and the processor of the program distribution server may distribute the program to be distributed, to a different computer. In the embodiment, two or more programs may be implemented as one program or one program may be implemented as two or more programs.

In the embodiment, a federated learning technology using a smart-contract-based blockchain will be described. According to this embodiment, improving an incentive for FL is expected to offer an effect of making a contribution from an economic viewpoint.

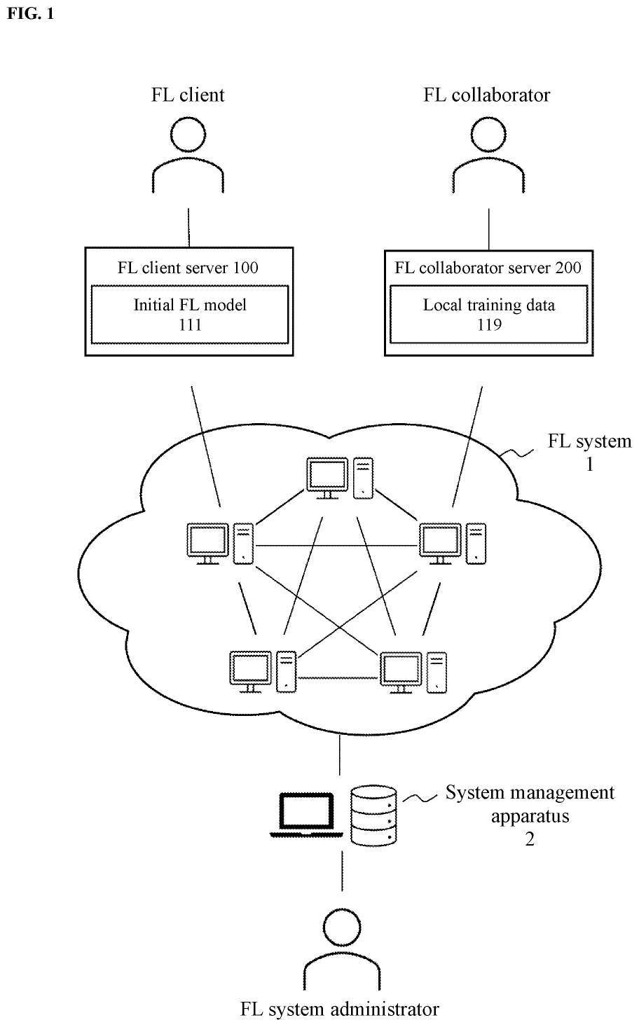

An outline of an overall configuration of an FL system using a smart-contract-based blockchain will first be described with reference to FIG. 1. FIG. 1 depicts an example of the overall configuration of the FL system using the smart-contract-based blockchain.

An FL client who wants to improve the performance of an AI model has an FL client server 100, which stores an initial FL model 111 that is an AI model to be trained by FL. An FL collaborator collaborating on FL has an FL collaborator server 200, which stores local training data 119 for training an AI model. An FL system 1 is a system for FL using a smart-contract-based blockchain. In the FL system, FL via a smart contract is executed between nodes participating in the FL system 1. An FL system management apparatus 2 is a server an FL system administrator has, the FL system administrator administrating the FL system 1.

It is assumed in this embodiment that the FL system 1 is executed through a blockchain network like EOS or Ethereum that can implement distributed applications (DApps) related to blockchain applications, such as smart contracts. This blockchain network is a network using a distributed ledger technology according to which a specific administrator posteriorly carries out registration and management of information processed by smart contracts.

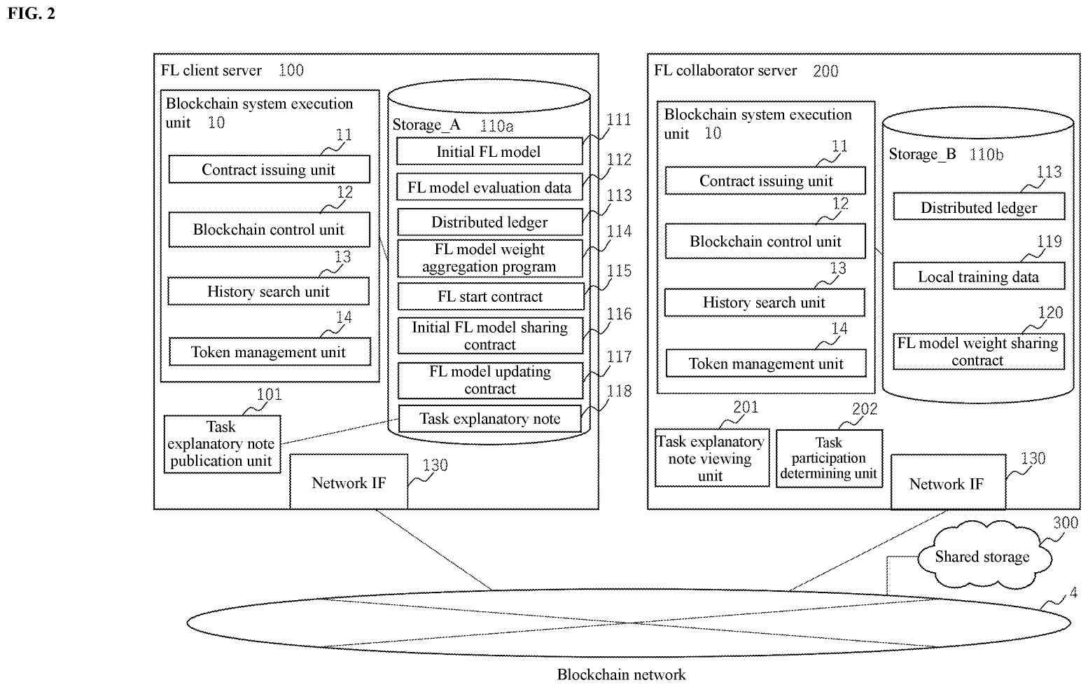

An example of a detailed configuration of the FL system will then be described with reference to FIG. 2. FIG. 2 depicts details of a configuration example of the FL system using the smart-contract-based blockchain.

As shown in FIG. 2, the FL system, which is a smart-contract-based blockchain system, includes the FL client server 100 operated by an FL client (user), and the FL collaborator server 200 operated by an FL collaborator (user). These information processing apparatuses 100 and 200, i.e., the FL client server 100 and FL collaborator server 200 are connected to a blockchain network 4, which is a peer-to-peer (P2P) network, in an autonomously distributed manner. It should be noted that in addition to the information processing apparatuses 100 and 200 shown in FIG. 2, a plurality of other information processing apparatuses are also connected to the network 4. For example, a plurality of AI model updating servers used by other FL participants and a plurality of AI model training servers used by other FL clients may also be connected to the network 4.

Each of the FL client server 100 and the FL collaborator server 200 includes a blockchain system execution unit 10, which stores a contract issuing unit 11 that issues a smart contract for FL, a blockchain control unit 12 that maintains a blockchain system in autonomous and distributed cooperation with an information processing apparatus connected to the network 4, a history search unit 13 that accesses record information in a distributed ledger 113 to be able to acquire contract information, and a token management unit 14 that manages the balance of tokens exchanged via a smart contract.

The FL client server 100 includes a storage 110a with, for example, a magnetic disk serving as a medium. The storage 110a of the FL client server 100 stores an initial FL model 111, FL model evaluation data 112, the distributed ledger 113, an FL model weight aggregation program 114, an FL start contract 115, an initial FL model sharing contract 116, an FL model updating contract 117, and a task explanatory note 118. The initial FL model 111 (initial federated learning model) is an AI model unique to the FL client server, the AI model not trained by FL yet. The FL model evaluation data 112 is data used to evaluate the accuracy of an FL model in an FL process. The distributed ledger 113 carries a record of contract information created by a smart contract. The FL model weight aggregation program 114 is a program for aggregating shared FL model weights from the FL collaborator server 200. The FL start contract 115 is a smart contract for acquiring an ID for identifying a collaborator at the start of FL. The initial FL model sharing contract 116 (initial federated learning model sharing contract) is a smart contract for sharing the initial FL model 111 with the FL collaborator server 200. The FL model updating contract 117 is a contract for evaluating the accuracy of a model whose model weights are aggregated by the model weight aggregation program 114 and executing updating of the model. The task explanatory note 118 is created by the FL client when necessary, and carries a description of the content of an FL task request. The task request content described in the task explanatory note 118 is shared by the entire smart-contract-based blockchain system via a task explanatory note publication unit 101.

The FL collaborator server 200 includes a storage 110b, and the distributed ledger 113 is stored in the storage 110b of the FL collaborator server 200 as is stored in the storage of the FL client server 100. In the storage 110b, local training data 119 and an FL model weight sharing contract 120 are stored as well. The local training data 119 is data for training the shared initial FL model 111 from the FL client server 100. The FL model weight sharing contract 120 is a smart contract for sharing a model weight obtained by local training with the FL client server.

The FL collaborator server 200 includes a task explanatory note viewing unit 201. Through the task explanatory note viewing unit 201, the FL collaborator is able to access the task explanatory note publication unit 101 and view the content of the task explanatory note. Based on the content of the task explanatory note 118 viewed through the task explanation note viewing unit 201, the FL participant determines whether or not to participate in FL, and a task participation determining unit 202 communicates a determination result entered, to the FL client server 100.

A shared storage 300 saves the initial FL model 111, a model weight, and the like as files, and takes charge of file sharing between the FL client server 100 and the FL collaborator server 200 by a smart contract. The shared storage 300 may be a centralized storage, in which case the FL client server 100 manages files, or may be a decentralized storage, in which case a peer-to-peer network system, such as an interplanetary file system (IPFS), manages files.

A network interface 130 is an interface for connecting to a given network. The network interface 130 is used, for example, to let the FL client server 100 and the FL collaborator server 200 connect to the blockchain network 4.

In this embodiment, the information processing apparatuses 100 and 200 each include functional units necessary for the present invention. This embodiment is, however, one example of embodiments of the present invention, and functional units other than the blockchain system execution unit 10 do not always need to present inside the information processing apparatuses 100 and 200. This, therefor, allows a devised configuration in which, for example, functional units are included in the shared storage 300.

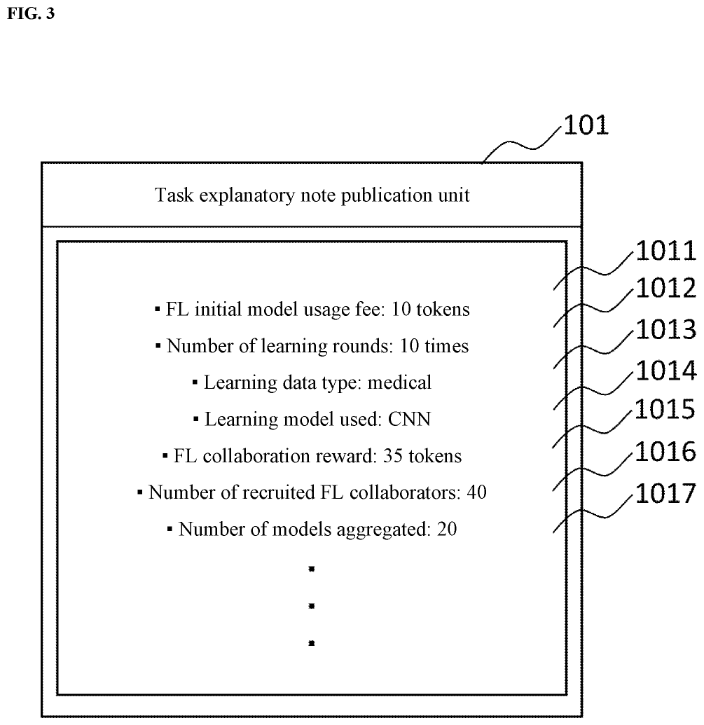

An example of the content of the task explanatory note will then be described with reference to FIG. 3. FIG. 3 depicts an example of the task explanatory note made open to the public.

The FL client who operates the FL client server 100 sets any given value as an initial FL model usage fee 1011. The FL client is able to obtain a token in exchange for sharing of the initial FL model 111 with the FL collaborator server 200 via the initial FL model sharing contract 116, the token corresponding to the value set as the initial FL model usage fee 1011.

The FL client inputs the following items to the task explanatory note 118: number of learning rounds 1012 that indicates the number of times of execution of the FL model updating contract 117; learning data type 1013 that indicates a field to which a learning model is applied; learning model used 1014 that indicates a base model network used in the initial FL model; FL collaboration reward 1015 that indicates an FL collaboration reward given in accordance with an FL model accuracy evaluation result after aggregation by the FL model updating contract 117, number of recruited FL collaborators 1016 that indicates the number of FL collaborators needed to issue the FL start contract; and number of models aggregated 1017 that indicates the number of models needed to execute the FL model updating contract 117.

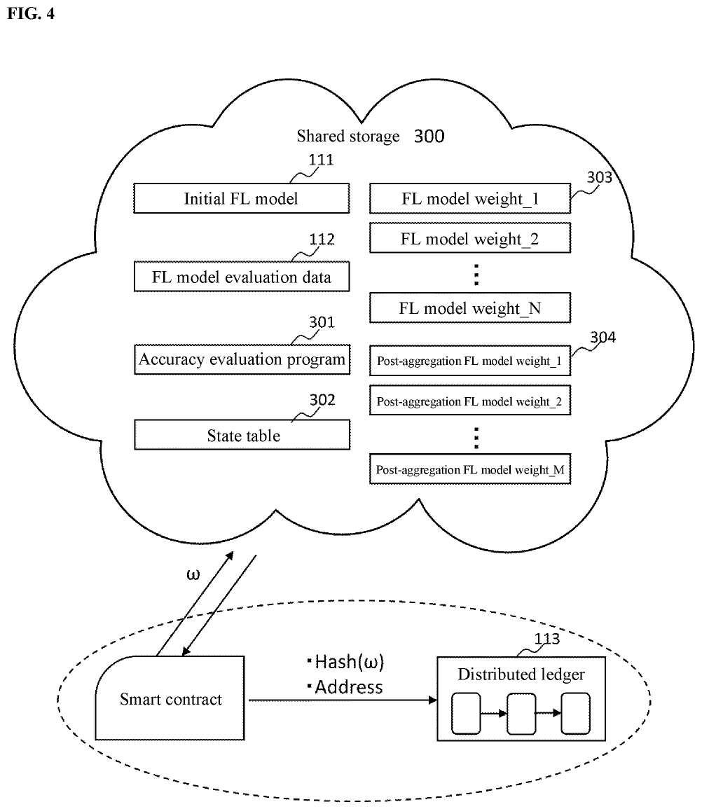

An example of information processing at the shared storage will then be described with reference to FIG. 4. FIG. 4 depicts a configuration of the shared storage and an example of information writing-in at execution of a smart contract.

On the blockchain, it is not easy to directly exchange a file with a large volume between the FL client server 100 and the FL collaborator server 200. To deal with this problem, the shared storage 300 is configured by using a technique (e.g., IPFS) by which unique address information can be assigned to a saved file. The FL client uploads the initial FL model 111 from the storage 110a of the FL client server 100 onto the shared storage 300, and transmits the address information to the FL collaborator server 200 via the initial FL model sharing contract 116, thereby sharing the initial FL model 111 with the FL collaborator server 200.

Every time consent to a contract for storing an FL model weight in the shared storage 300 is given, an FL model weight 303 and a post-aggregation model weight 304 are stored in the shared storage 300, and hash values for the stored FL model weight 303 and post-aggregation model weight 304 and address information on addresses on the shared storage are written to the distributed ledger 113.

A state table 302 stores meta-information on the FL model weight 303, and this meta-information is referred to when contract verification is carried out. The accuracy evaluation program 301 is called when the FL model updating contract 117 is executed. Evaluation data 112, which is uploaded from the FL client server 100 onto the shared storage 300, is used to evaluate the accuracy of aggregated models and a degree of contribution of the FL collaborator server 200.

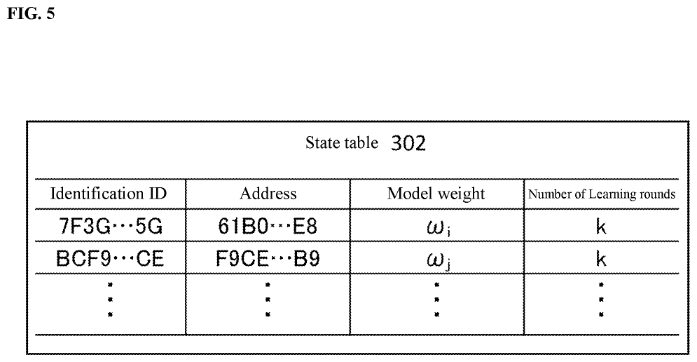

The state table 302 will be described in detail with reference to FIG. 5. FIG. 5 depicts an example of the state table. The state table 302 holds information written thereto, which includes an identification ID of the FL client server 100 or the FL collaborator server 200 having uploaded the learning model weight 303 that is a model weight value, address information on the address of the FL model weight 303 on the shared storage 300, and learning round information. The information written to the state table 302 is referred to when the FL model weight sharing contract 120 and the FL model updating contract 117 are verified to determine whether their contract contents are correct.

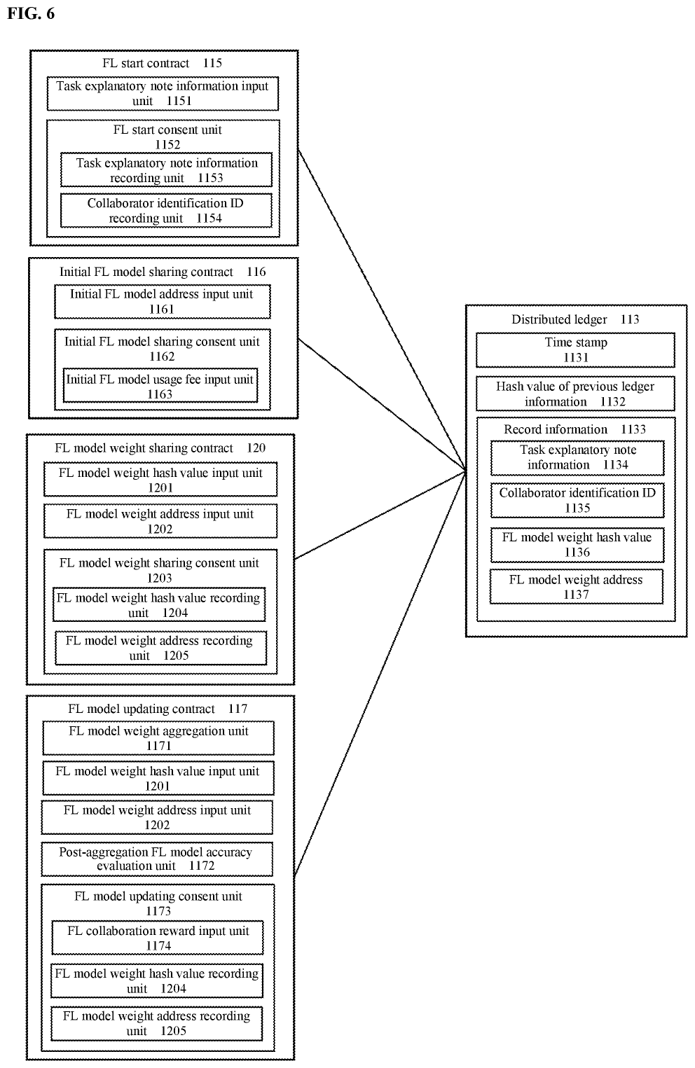

A configuration example of an FL smart contract and of the distributed ledger will then be described with reference to FIG. 6. FIG. 6 depicts a configuration example of the FL smart contract and of the distributed ledger.

The FL start contract 115 is a contract that the FL client issues from the FL client server 100, and includes a task explanatory note information input unit 1151 that inputs FL task information described in the task explanatory note 118, and an FL start consent unit 1152 that is executed at consent to the contract. Inside the recording information 1133 of the distributed ledger 113, the FL start consent unit 1152 includes a task explanatory note information recording unit 1153 that records FL task information inputted to the task explanatory note information input unit 1151, and a collaborator identification ID recording unit 1154 that records a collaborator identification ID 1135.

The initial FL model sharing contract 116 is a contract that the Fl client issues from the FL client server 100, and includes an initial model address input unit 1161 that inputs address information on the initial FL model 111 uploaded to the shared storage 300, and an initial FL model sharing consent unit 1162 that is executed at consent to the contract. The initial FL model sharing consent unit 1162 includes a model usage fee input unit 1163 that inputs the initial FL model usage fee 1011.

The FL model weight sharing contract 120 is a contract that the FL collaborator issues from the FL collaborator server 200, and includes a hashed FL model weight input unit 1201 that inputs a hash value for the FL model weight 303 uploaded to the shared storage 300 by the FL collaborator server 200, an FL model weight address input unit 1202 that inputs address information on the FL model weight 303, and an FL model weight sharing consent unit 1203 that is executed at consent to the contract. Inside the recording information 1133 of the distributed ledger 113, the FL model weight sharing consent unit 1203 includes a hashed FL model weight recording unit 1204 that records a hashed FL model weight inputted to the hashed FL model weight input unit 1201, and an FL model weight address recording unit 1205 that records FL model weight address information inputted to the FL model weight address input unit 1202.

The FL model updating contract 117 is a contract that the FL client issues from the FL client server 100, and includes an FL model weight aggregation unit 1171 that aggregates FL model weights 303 shared according to the initial FL model sharing contract 116, from the FL collaborator server 200, a hashed FL model weight input unit 1201 that inputs a hash value for a post-aggregation model weight, an FL model weight address input unit 1202 that inputs address information on the post-aggregation FL model weight 304 uploaded to the shared storage 300 by the FL client, a post-aggregation model accuracy evaluation unit 1172 that evaluates the performance of a post-aggregation model, using the model evaluation data 112 and the accuracy evaluation program 301, and an FL model updating consent unit 1173 that is executed at consent to the contract. Inside the record information 1133 of the distributed ledger 113, the FL model updating consent unit 1173 includes an FL collaboration reward input unit 1174 that inputs a reward the FL collaborator deserves, the reward corresponding to a model evaluation result given by the post-aggregation model accuracy evaluation unit 1172, a hashed FL model weight recording unit 1204 that records a hashed FL model weight inputted to the hashed FL model weight input unit 1201, and an FL model weight address recording unit 1205 that records FL model weight address information inputted to the FL model weight address input unit 1202.

The distributed ledger 113 is connected to vertical columns of nodes, making up a so-called blockchain. The distributed ledger 113 includes a time stamp 1131, a hash value of previous ledger information 1132, and the record information 1133. The time stamp 1131 is information indicating the day and time the ledger is created. The previous ledger information hash value 1132 is a value that is generated based on a hash function preset in previous ledger information. The record information 1133 is the main body of information recorded by each contract approval, and includes, for example, task explanatory note information 1134, a collaborator identification ID 1135, an FL model weight hash value 1136, and an FL model weight address 1137.

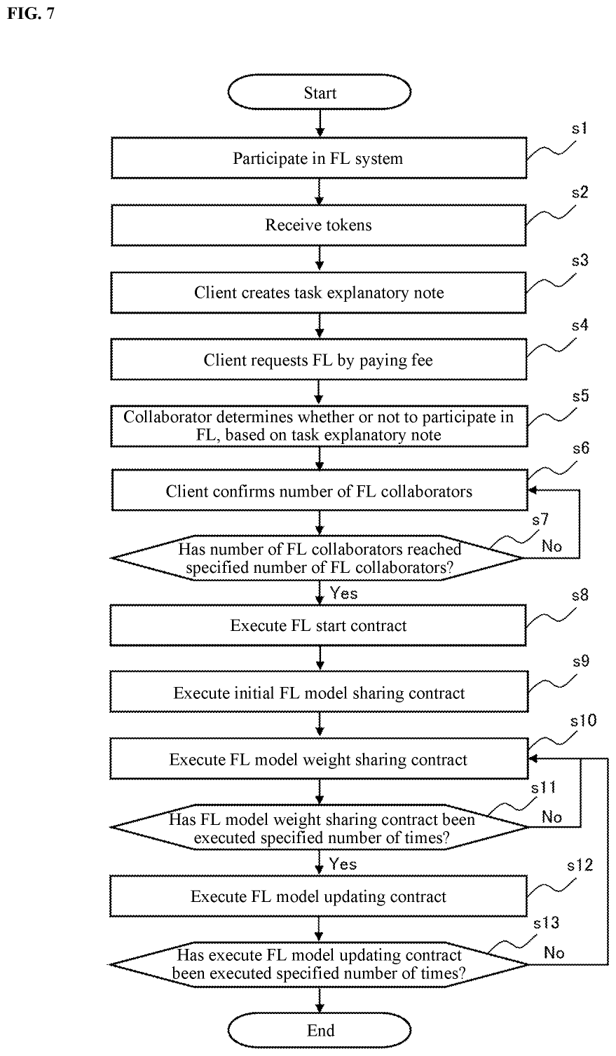

An example of a flow of use of the FL system will then be described with reference to FIG. 7. FIG. 7 is a flowchart showing an example of the flow of use of the FL system using the smart-contract-based blockchain. Processes at s1 to s13 will hereinafter be described.

At s1, the FL client and the FL collaborator each pay a certain amount of fee to the FL system, and register their information processing apparatuses, i.e., the FL client server 100 and the FL collaborator server 200, respectively.

At s2, the FL system gives a certain amount of tokens to the client or the collaborator who has registered the FL client server 100 or the FL collaborator server 200 at s1. The given tokens are put under management of the token management unit 14.

At s3, to recruit FL collaborators, the FL client creates a task explanatory note 118 describing the content of an AI model training task to be requested of the FL system. The FL client creates the task explanatory note 118 including an entry of the initial FL model usage fee 1011.

At s4, the FL client pays a fee in token, and makes the FL task explanatory note 118 created at s3 open to the public on the FL system, via the task explanatory note publication unit 101. At s4, the FL client pays the system administrator the fee, e.g., pays the system management apparatus 2 (FL system administrator) the fee.

At s5, based on the content of the FL task explanatory note 110, the FL collaborator determines whether or not to participate in the task, and inputs a determination result to the task participation determining unit 202, after which the determination result is transmitted to the FL client server 100.

At s6, the FL client confirms the task participation determination result. At s7, the FL client determines whether the number of FL collaborators has reached the number of recruited FL collaborators 1016 entered in the task explanatory note 118 as a result of an additional collaborator's participation indicated in the task participation determination result confirmed at s6. When Yes results (s7: Yes), s8 is executed. When No results (s7: No), s6 is executed.

At s8, the FL start contract 115 is executed, the FL start contract 115 being issued by the FL client from the FL client server 100.

At step s9, the initial FL model sharing contract 116 is executed, the initial FL model sharing contract 116 being issued by the FL client from the FL client server 100.

At step s10, the FL model weight sharing contract 120 is executed, the FL model weight sharing contract 120 being issued by the FL collaborator from the FL collaborator server 200.

At step s11, the FL system determines whether the number of executions of the FL model weight sharing contract 120 has reached the number of aggregated models 1017 entered in the task explanatory note 118. When Yes results (s11: Yes), s12 is executed. When No results (s11: No), s10 is executed.

At step s12, the FL model updating contract 117 is executed, the FL model updating contract 117 being issued by the FL client from the FL client server 100.

At s13, the FL system determines whether the number of executions of the FL model updating contract 117 has reached the number of learning rounds 1012 entered in the task explanatory note 118. When No results (s13: No), s10 is executed. When Yes results (s13: Yes), the sequence of steps come to an end.

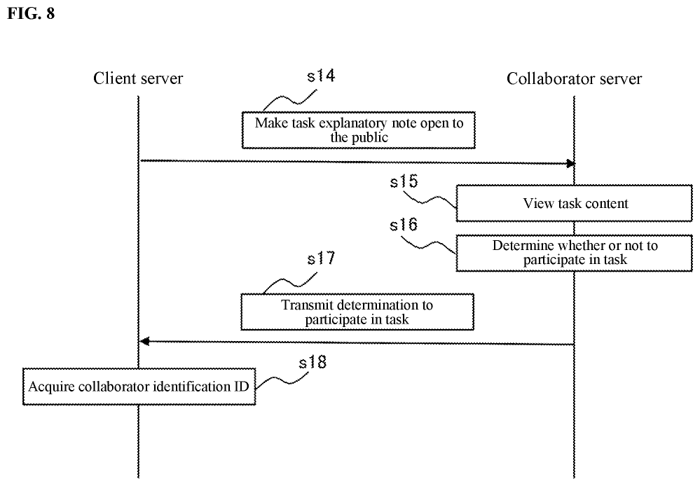

Details of task participation determination will then be described with reference to FIG. 8. FIG. 8 depicts an example of a sequence to make task participation determination A specific operation at s5, which is the FL collaborator's determining whether or not to participate in FL, based on the task explanatory note, will be described below as processes at s14 to s18.

At s14, the FL client server 100 makes the task explanatory note 118 created by the FL client open to FL collaborators through the task explanatory note publication unit 101.

At s15, the FL collaborator server 200 acquires data of the task explanatory note 118 made open to the public by the FL client, and the FL collaborator views the content of the task explanatory note 118 through the task explanatory note viewing unit 201.

At s16, based on the content of the task explanatory note 118 having viewed at s15, the FL collaborator determines whether or not to participate in the task, through the task participation determining unit 202.

When the FL collaborator has determined at s16 to participate in the task, the FL collaborator server 200, at s17, transmits participation information through the task participation determining unit 202.

At step s18, the FL client server 100 acquires a collaborator identification ID from the participation information transmitted at step s17 through the task participation determining unit 202.

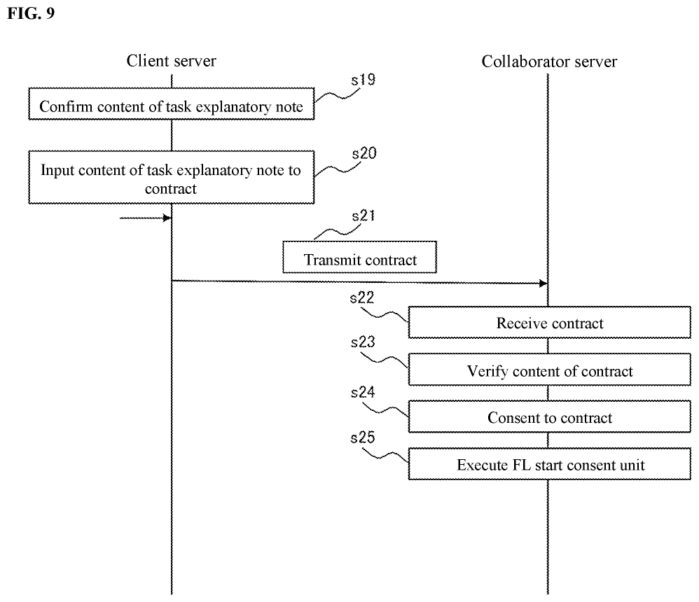

Details of execution of the FL start contract will then be described with reference to FIG. 9. FIG. 9 depicts an example of a sequence to execute the FL start contract. A specific operation at s8, which is execution of the FL start contract, will be described below as processes at s19 to s25.

At s19, the FL client confirms the content of the task explanatory note 118 created at s3.

At s20, the FL client inputs the content of the task explanatory note 118 confirmed at s19, to the task explanatory note information input unit 1151 of the FL start contract 115.

At s21, the FL client transmits the contract. In other words, the FL client server 100 transmits the FL start contract 115 to the FL collaborator through the contract issuing unit 11.

At s22, the FL collaborator receives the contract. In other words, the FL collaborator server 200 receives the contract transmitted by the FL client at s21.

At s23, the FL collaborator verifies whether the content of the task explanatory note information input unit 1151 of the FL start contract 115 received at step s22 is correct.

At s24, the FL collaborator carries out an operation of putting an electronic signature or the like, thus consenting to the contract.

At s25, the FL start consent unit 1152 is executed, and the task explanatory note information recording unit 1153 and the collaborator identification ID recording unit 1154 record the task explanatory note information 1134 and the collaborator identification ID 1135, respectively, in the record information 1133 of the distributed ledger 113.

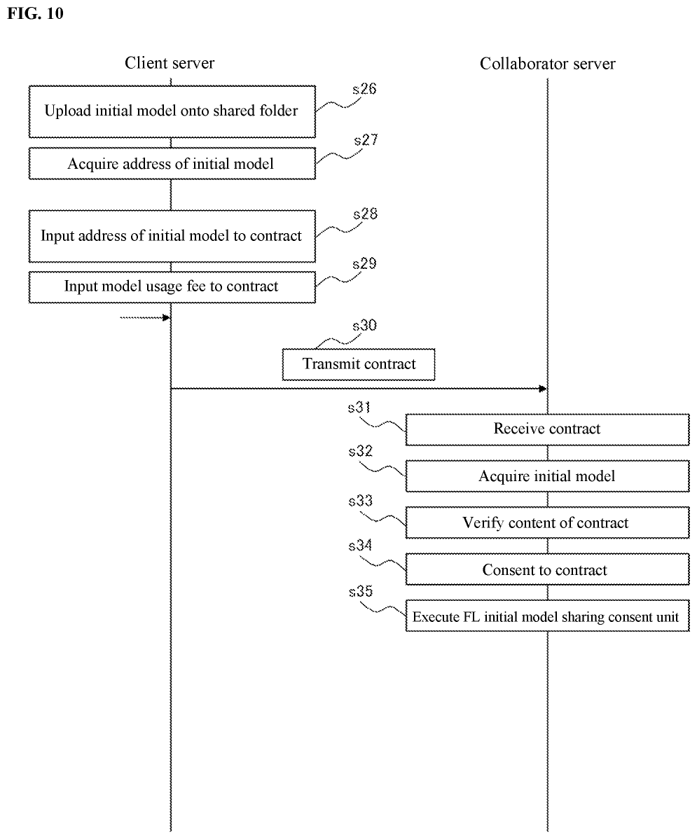

Details of execution of the initial FL model sharing contract will then be described with reference to FIG. 10. FIG. 10 depicts an example of a sequence to execute the initial FL model sharing contract. A specific operation at s9, which is execution of the initial FL model sharing contract 116, will be described below as processes at s26 to s35.

At s26, the FL client uploads the initial FL model 111 stored in the FL client server 100 onto the shared storage 300.

At s27, the FL client acquires address information on the address of the initial FL model 110 on the shared storage 300, the initial FL model 110 being uploaded onto the shared storage 300 at s26.

At s28, the FL client inputs the address information on the initial FL model 111, the address information being acquired at step s27, to the initial FL model address input unit 1161 of the initial FL model sharing contract 116.

At step s29, the FL client inputs a value entered in the initial FL model usage fee 1011 of the task explanatory note 118, to the initial FL model usage fee input unit 1163 in the initial FL model sharing consent unit 1162 of the initial FL model sharing contract 116.

At step s30, the FL client transmits the contract. In other words, the FL client server 100 transmits the initial FL model sharing contract 116 to the FL collaborator through the contract issuing unit 11.

At s31, the FL collaborator receives the contract. In other words, the FL collaborator server 200 receives the contract transmitted by the FL client at s30.

At step s32, the FL collaborator acquires address information on the initial FL model 111, the address information being inputted to the initial FL model address input unit 1161, and downloads the initial FL model 111.

At step s33, the FL collaborator verifies whether the initial FL model 111 acquired at step s32 is correct and whether the initial FL model usage fee inputted to the initial FL model usage fee input unit 1163 of the initial FL model sharing contract 116 is correct.

At step s34, the FL collaborator carries out an operation of putting an electronic signature and the like, thus consenting to the contract.

At step s35, the initial FL model sharing consent unit 1162 is executed, and the FL collaborator pays the FL client the tokens corresponding to the value inputted to the initial FL model usage fee input unit 1163.

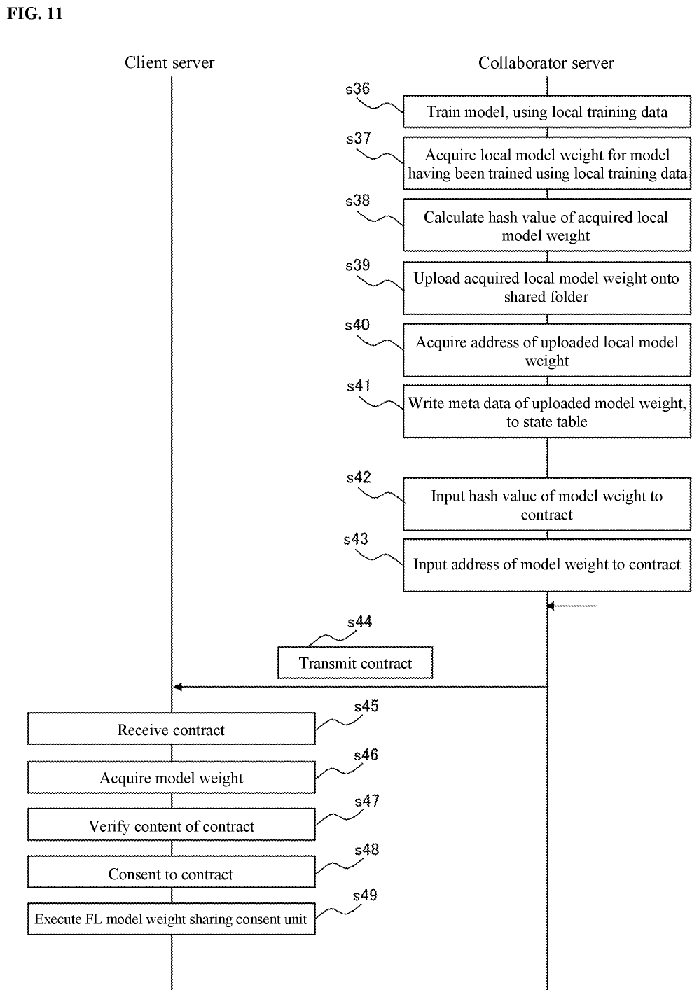

Details of execution of the FL model weight sharing contract will then be described with reference to FIG. 11. FIG. 11 depicts an example of a sequence to execute the FL model weight sharing contract. A specific operation at s10, which is execution of the FL model weight sharing contract 120, will be described below as processes at s36 to s49.

At s36, the FL collaborator trains an FL model, using the local training data 119 on the FL collaborator server 200.

At s37, the FL collaborator server 200 acquires a weight for the FL model that the FL collaborator has trained using the local training data 119.

At step s38, using a hash function, the FL collaborator server 200 calculates a hash value of the weight for the FL model, from the weight for the FL model acquired at step s37.

At step s39, the weight for the FL model trained is defined as the FL model weight 303, and the FL collaborator uploads the FL model weight 303 onto the shared storage 300.

At step s40, the FL collaborator acquires address information on the address of the FL model weight 303 on the shared storage 300, the address information being uploaded to the shared storage 300 at step s39.

At step s41, the FL collaborator inputs metadata to the state table 302, the meta data including a weight value represented by the FL model weight 303 uploaded at step s39, the number of learning rounds, an address, and collaborator identification ID information.

At step s42, the FL collaborator inputs the hash value of the FL model weight 303, the hash value being calculated at step s38, to the FL model weight hash value input unit 1201 of the FL model weight sharing contract 120.

At step s43, the FL collaborator inputs the address information on the FL model weight 303, the address information being acquired at step s40, to the FL model weight address input unit 1202 of the FL model weight sharing contract 120.

At s44, the FL collaborator transmits the contract. In other words, the FL collaborator server 200 transmits the FL model weight sharing contract 120 to the FL client through the contract issuing unit 11.

At step s45, the FL client receives the contract. In other words, the FL client server 100 receives the contract transmitted by the FL collaborator at s44.

At step s46, the FL client acquires the address information on the FL model weight 303, the address information being inputted to the FL model weight address input unit 1202, and downloads the FL model weight 303.

At step s47, the FL client checks the FL model weight 303 acquired at step s46 against meta information in the state table to verify whether the FL model weight 303 is correct.

At step s48, the FL client carries out an operation of putting an electronic signature and the like, thus consenting to the contract.

At step s49, the FL model weight sharing consent unit 1203 is executed, and the FL model weight hash value recording unit 1204 and the FL model weight address recording unit 1205 record the FL model weight hash value 1136 and the FL model weight address 1137, respectively, in the record information 1133 of the distributed ledger 113.

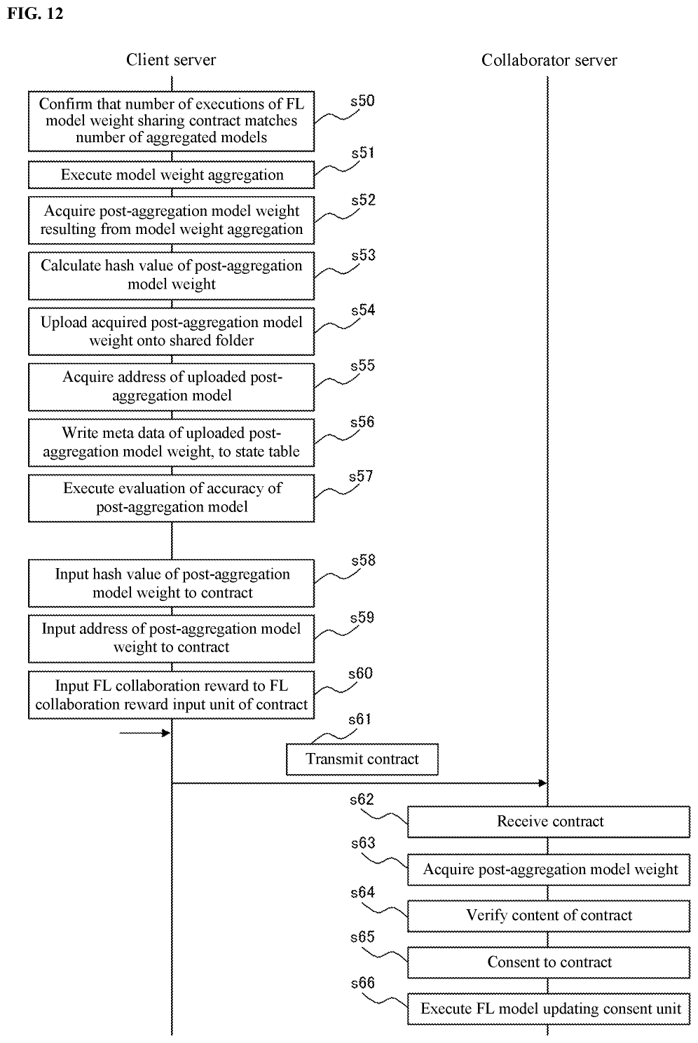

Details of execution of the FL model updating contract will then be described with reference to FIG. 12. FIG. 12 depicts an example of a sequence to execute the FL model updating contract. A specific operation at s12, which is execution of the FL model updating contract 117, will be described below as processes at s50 to s66.

At step s50, the FL client confirms that the number of executions of the FL model weight sharing contract 120 matches the number of aggregated models 1017 entered in the task explanatory note 118.

At step s51, the FL model weight aggregation program 114 is executed. The FL model weight aggregation program 114 thus aggregates a plurality of FL model weights 303 that are shared according to the FL model weight sharing contract 120. Referring to the state table 302 and the record information 1133, for example, the FL model weight aggregation program 114 sequentially reads the FL model weights 303 in the order of reading new one first, with the number of read FL model weights 303 matching the number of aggregated models 1017 entered in the task explanatory note 118, and averages weight values, thereby aggregating the model weights into a post-aggregation model weight.

At step s52, the FL client acquires an FL model weight. In other words, the FL client server 100 acquires a new FL model weight, i.e., a post-aggregation FL model weight resulting from the aggregation at s51.

At step s53, a hash value is calculated. Specifically, using a hash function, the FL client server 100 calculates a hash value of the post-aggregation FL model weight from the post-aggregation FL model weight acquired at s52.

At step s54, the FL client uploads the post-aggregation FL model weight onto the shared storage 300, as the post-aggregation FL model weight 304.

At step s55, the FL client acquires the address of the post-aggregation FL model weight 304 uploaded at step s54.

At step s56, the FL client inputs meta data to the state table 302, the meta data including a weight value represented by the post-aggregation FL model weight 304 uploaded at step s54, the number of learning rounds, an address, and collaborator identification ID information.

At step s57, the FL client quantifies a degree of contribution of the FL collaborator. Specifically, the FL client server 100 executes the accuracy evaluation program 301 stored in the shared storage 300, using the model evaluation data 112, to evaluate the accuracy of the post-aggregation FL model, and quantifies a degree of contribution of each FL collaborator, using a Shapley value or the like.

At step s58, the FL client inputs the hash value of the post-aggregation FL model weight 304, the hash value being calculated at step s53, to the FL model weight hash value input unit 1201 of the FL model updating contract 117.

At step s59, the FL client acquires address information on the address of the post-aggregation FL model weight on the shared storage 300, the post-aggregation FL model weight being uploaded to the shared storage 300 at step s54. In addition, the FL client inputs the address information to the FL model weight address input unit 1202.

At step s60, in accordance with a result of evaluation of a degree of contribution of each FL collaborator, the evaluation being made by the accuracy evaluation program 301 at step s57, the FL client inputs a value representing a distributed portion of the FL collaboration reward 1015 entered in the task explanatory note 118, to the FL collaboration reward input unit 1174 of the FL model updating consent unit 1173.

At step s61, the FL client transmits the contract. In other words, the FL client server 100 transmits the FL model updating contract 117 to the FL collaborator through the contract issuing unit 11.

At s62, the FL collaborator receives the contract. In other words, the FL collaborator server 200 receives the contract transmitted by the FL client at s61.

At step s63, the FL collaborator acquires the address information on the post-aggregation FL model weight 304, the address information being inputted to the FL model weight address input unit 1202, and downloads the post-aggregation FL model weight 304.

At step s64, the FL collaborator checks the post-aggregation FL model weight 304 against meta information in the state table 302, and verifies whether the post-aggregation FL model weight 304 is correct. In addition, the FL collaborator executes the accuracy evaluation program 301, using the model evaluation data 112, to verify whether a reward inputted to the FL collaboration reward input unit 1174 of the FL model updating consent unit 1173, the reward being paid in token, is correct.

At step s65, the FL collaborator carries out an operation of putting an electronic signature or the like, thus consenting to the contract.

At step s66, the FL model updating consent unit 1173 is executed, and the FL model weight hash value recording unit 1204 and the FL model weight address recording unit 1205 record the FL model weight hash value 1136 and the FL model weight address 1137, respectively, in the record information 1133 of the distributed ledger 113. At execution of the FL model updating consent unit 1173, the FL client pays the FL collaborator tokens corresponding to a value inputted to the FL collaboration reward input unit 1174.

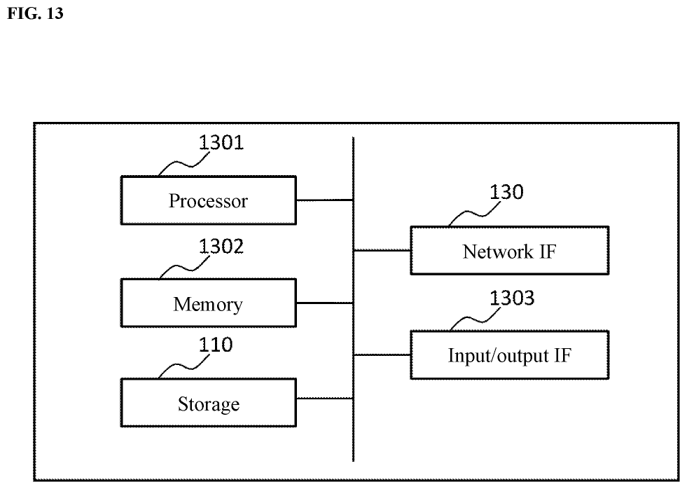

An example of a hardware configuration of the information processing apparatus used in the system of this embodiment will then be described with reference to FIG. 13. FIG. 13 depicts an example of the hardware configuration of the information processing apparatus used in this embodiment.

As shown in FIG. 13, the information processing apparatus is a computer configured to carry out information processing. The information processing apparatus includes, for example, a processor 1301, a memory 1302, a storage 110, a network IF 130, and an input/output IF 1303.

The processor 1301 is a main component that executes a given process. The memory 1302 is a main storage device that stores data, and the processor 1301 reads data from the memory 1302 to carry out a process. The storage 110 stores various data. The network IF 130 is an interface used to input/output data via a given network. For example, the network IF 130 is used to input/output data via the blockchain network 4. The input/output IF 1303 is an interface used to receive/send input/output data from/to a connected device.

For example, the FL client server 100 (first information processing apparatus) and the FL collaborator server 200 (second information processing apparatus) can be made identical in hardware configuration with each other. The blockchain system execution unit 10, the task explanatory note publication unit 101, the FL model weight aggregation program 114, the FL start contract 115, the initial FL model sharing contract 116, the FL model updating contract 117, the FL model weight sharing contract 120, the task explanatory note viewing unit 201, the task participation determining unit 202, and the like can be provided by properly using various pieces of hardware.

The first information processing apparatus and the second information processing apparatus each receive input data and send output data from and to a user by a given method. For example, a given input device and output device may be connected to the input/output IF and data may be inputted or outputted through these input device and output device. Alternatively, a given computer may be connected to the information processing apparatus via the network IF and data may be inputted/outputted using the computer.

The FL system may be configured such that, for example, the shared storage 300 is disposed in an information processing apparatus that is connected to the blockchain network 4 and that is different from the information processing apparatuses 100 and 200.

According to this embodiment, the following system is provided as an example. Provided is the smart-contract-based blockchain system in which the FL client server 100 includes the initial FL model 111, and the initial FL model usage fee input unit 1163 included in the initial FL model sharing contract 116. When the initial FL model 111 is shared with the FL collaborator server 200, the initial FL model usage fee received from the FL collaborator server 200 is inputted to the initial FL model usage fee input unit 1163, and the FL client receives a reward in exchange for sharing the initial FL model 111 with the FL collaborator server 200.

The FL collaborator server 200 includes the local training data 119 for training a shared AI model, and shares a new weight obtained through the training with the AI model providing server. i.e., client server through the FL model weight sharing contract 120. When a certain number of weights are shared, aggregation of FL model weights and evaluation of post-aggregation FL models are executed through the FL model updating contract 117, and a reward based on an evaluation result is paid to the FL trainer, i.e., FL client.

According to the present disclosure, the FL client is allowed to receive an incentive, i.e., a reward paid in token in exchange for sharing the initial FL model with the FL collaborator. This means that incentive design for rewarding the FL client with an incentive, the incentive design allowing the initial FL model to be shared among the entire nodes in the begging, is achieved.

It should be noted that the present invention is not limited to the above embodiment but includes various modifications. For example, the above embodiment has been described in detail for easy understanding of the present invention, and is not necessarily limited to an embodiment including all constituent elements described above. Some constituent elements of a certain embodiment may be replaced with constituent elements of another embodiment, and a constituent element of another embodiment may be added to a constituent element of a certain embodiment. In addition, some of constituent elements of each embodiment can be deleted therefrom or add to or replaced with constituent elements of another embodiment.

What is claimed is:

1. A federated learning system using a smart-contract-based blockchain technology, the system comprising:
a first information processing apparatus including an initial federated learning model; and
a second information processing apparatus that trains an initial federated learning model delivered from the first information processing apparatus, wherein
the first information processing apparatus includes an initial federated learning model sharing contract that is a smart contract used to share the initial federated learning model with the second information processing apparatus, the smart contract including reward information on a reward as a token that a user of the first information processing apparatus receives from a user of the second information processing apparatus for the sharing of the initial federated learning model.

2. The federated learning system according to claim 1, wherein the initial federated learning model sharing contract includes a model usage fee input unit that a user of the first information processing apparatus uses to input the reward information.

3. The federated learning system according to claim 2, wherein
the first information processing apparatus includes a task explanatory note publication unit that makes a task explanatory note open to the second information processing apparatus, the task explanatory note including a model usage fee, a reward for federated learning, and a task content of federated learning, and
the second information processing apparatus includes a task participation determining unit to which a user inputs the user's participation in federated learning.

4. A federated learning system using a smart-contract-based blockchain technology, the system comprising an initial federated learning model sharing contract that is a smart contract used to cause a second information processing apparatus that trains a model to share an initial federated learning model included in a first information processing apparatus that requests federated learning, the smart contract including reward information on a reward as a token that a user of the first information processing apparatus receives from a user of the second information processing apparatus for the sharing of the initial federated learning model.

5. The federated learning system according to claim 4, wherein the initial federated learning model sharing contract includes a model usage fee input unit that a user of the first information processing apparatus uses to input the reward information.

6. The federated learning system according to claim 5, wherein
the first information processing apparatus includes a task explanatory note publication unit that makes a task explanatory note open to the second information processing apparatus, the task explanatory note including a model usage fee, a reward for federated learning, and a task content of federated learning, and
the second information processing apparatus includes a task participation determining unit to which a user inputs the user's participation in federated learning.

7. A federated learning method using a smart-contract-based blockchain technology, the method comprising:
a first information processing apparatuses' causing a second information processing apparatus to share an initial federated learning model, using an initial federated learning model sharing contract that is a smart contract used to allow the first information processing apparatus to cause the second information processor that trains a model to share the initial federated learning model; and
the first information processing apparatuses' acquiring a reward as a token when the second information processing apparatus shares the initial federated learning model.

8. The federated learning method according to claim 7, further comprising a user's inputting the reward to the initial federated learning model sharing contract, the user being a user of the first information processing apparatus.

9. The federated learning method according to claim 8, comprising:
a user's creating a task explanatory note including a model usage fee, a reward for federated learning, and a task content of federated learning, the user being a user of the first information processing apparatus;
a user's making the task explanatory note open to public, the user being a user of the first information processing apparatus; and
a user's determining whether or not to participate in federated learning, based on a descriptive content of the task explanatory note, the user being a user of the second information processing apparatus.
